(19) United States
(12) Patent Application Publication
(10) Pub. No.: US 2006/0086195 A1
(43) Pub. Date: Apr. 27, 2006

(54) Remote terminal unit

(75) Inventor: Robert K. Hunt, Vista, CA (US)

Correspondence Address: KEITH R. DERRINGTON;SIMMONS & DERRINGTON, L.L.P, FROST BANK BUILDING, 6750 WEST LOOP SOUTH, SUITE 920, BELLAIRE, TX, 77401, US

(73) Assignee: IWA Corporation

(21) Appl. No.: 10/960,845

(22) Filed: Oct. 7, 2004

(51) Int. Cl. G01F 15/00

(52) U.S. Cl. 73/861.77

(57) ABSTRACT

A meter useful in measuring flow, such as electrical, gas, and water flow, where the meter includes a rotating wheel with markings that rotates in response to the flow sensed by the meter. The meter further includes an illumination source directing light to the surface of the rotating wheel, where a portion of the light is absorbed by the markings, and a portion of the light is reflected by the remaining surface of the rotating wheel. A detector array is included that reads the reflections and converts the readings into a signal. The signal can be analyzed in order to ascertain the rate and amount of flow sensed by the meter.

### BACKGROUND OF THE INVENTION

1. Field of the Invention

The invention relates generally to the field of flow metering. More specifically, the present invention relates to a device and method that is capable of metering and measuring the flow of electrical, water, or gas flow.

2. Description of Related Art

Typically end users of utilities such as electricity, water, and gas, are equipped with meters at the point of supply. Where the point of supply is usually a residence or a business. The general principle of these flow meters is that the flow (either electrical, gas, or water) is used to produce a rotation or movement of a member, where the rotating or moving member is mechanically connected with indicator dials that record the usage of the utility by measuring its total flow.

While these indicator dials are capable of substantially reflecting the usage of the utilities, they must be visually accessed periodically in order for the supplier of the utility to record the measured total flow. Conducting visual access by actual individuals presents additional problems, such as cost, time, and concern for the safety of the individual meter readers. Accordingly telemetry processes have been developed that can transmit flow usage data either directly to the utility provider or to a central location where retrieval of the data is less time consuming and safer.

One such device includes a photocell within the flow meter, where the flow meter includes a rotating wheel that rotates in response to the flow of electricity sensed by the meter. The wheel further includes a mark on a portion of the wheel, where the photocell is able to record the presence of the mark based on the amount of light absorbed by the mark in contrast to the light reflected by the wheel. Tracking the movement of the mark in turn monitors the number of rotations of the wheel that can then be evaluated to determine the usage of electricity sensed by the meter. However, the photocell can be disabled if an external light source is directed at it that mutes the distinction between the light reflecting and light absorbing portions of the wheel's surface. Moreover, the photocell is a single light recording source, and is unable to distinguish the rotational direction of the wheel. It is important to know the directional rotation of the wheel since manipulating the meter to cause the wheel to rotate backwards can cause the flow measured by the meter to be less than the actual amount of flow that has passed through the meter. Therefore, there exists a need for a flow metering system that is reliable, is able to detect tampering, and enhances accurate meter readings.

### BRIEF SUMMARY OF THE INVENTION

The present invention.

### BRIEF DESCRIPTION OF THE SEVERAL VIEWS OF THE DRAWING

FIG. 1 depicts a perspective view of a prior art device.

FIG. 2 illustrates a perspective view of a rotating wheel.

FIG. 3 portrays a side view of one embodiment of the present invention.

FIG. 4 demonstrates a functional block diagram of a portion of the elements of the present invention.

FIG. 5 depicts a flow chart of a process of an embodiment of the present invention.

FIGS. 6A-6C illustrate the possible output of a detector array.

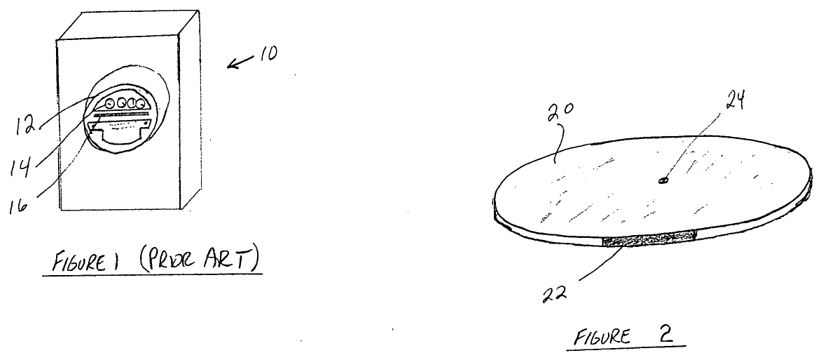

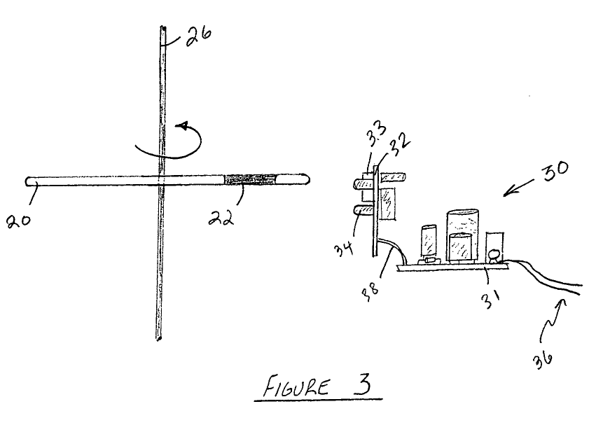

### DETAILED DESCRIPTION OF THE INVENTION

The present invention disclosed herein involves a device for use with a meter, where the meter is capable of sensing and measuring flow, where the flow under consideration includes electrical flow, gas flow, and fluid flow such as water and other liquids. With reference to FIG. 3, one embodiment of a remote terminal unit 30 of the present invention is shown in a side view. The remote terminal unit (RTU) 30 comprises an electrical circuit (disclosed later herein in more detail), preferably formed on a first and second circuit board (31, 32). The first circuit board 31 is generally horizontal whereas the second circuit board 32 is generally vertical. A series of electrically conducting wires 38 can be included to conduct electrical current between the first and second circuit board (31, 32) as well as provide structural connect the first and second circuit boards (31, 32).

Among the components of the RTU 30 is at least one source of electromagnetic radiation, such as a light emitting diode (LED) 34. Preferably the RTU 30 is equipped with three LEDs 34. Disposed on the second circuit board 32 proximate to the LED 34 is a detector array 33, such as a charge coupled device. The function of the detector array 33 is to receive optical images, such as light, and convert the image into an electrical signal.

The present invention includes a rotating wheel 20 that rotates in response to the amount of flow being sensed by the meter (not shown). Producing rotation of the rotating wheel 20 relative to the flow being sensed by the meter is well within the capabilities of those skilled in the art. In one example however, in situations where the present invention is used in an electrical meter, the rotating wheel 20 could be motivated by a motor driven by the electricity passing through the meter, thereby providing a direct correlation of the flow passing through the meter and the rotational rate of the rotating wheel 20. A stripe 22 should be provided onto the outer surface of the rotating wheel 20, where the stripe 22 is comprised of a material capable of absorbing electromagnetic radiation; where the electromagnetic radiation includes light produced by the LED's 34. Further, the remaining outer surface of the rotating wheel 20 should be generally reflective.

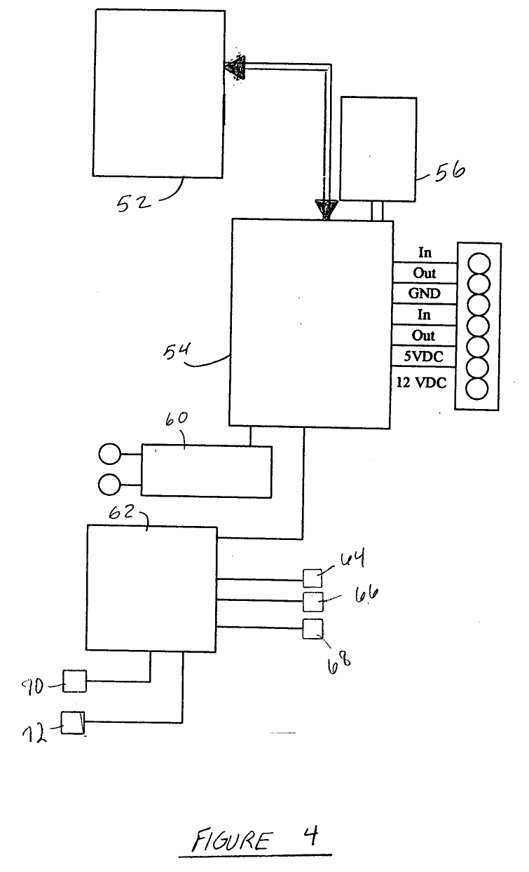

With reference now to FIG. 4, the processor 54 of an embodiment of the present invention is shown with a power line carrier (PLC) 52 and a power supply 62. The power supply 62 is shown connected to two sources of 120 VAC power (70, 72) or one source of 240 VAC power, where the power supply 62 converts this power into electrical power having the appropriate voltage and current useable by the processor 54. In addition to providing appropriate power for the processor 54, the power supply 62 also provides 5 VDC 64, a ground connection 66, and 12 VDC 68.

The PLC 52 can include a central terminal unit (not shown) that acts as a receiving unit for receiving data packets from multiple processors 54. A central terminal unit (CTU) is a device that stores meter usage data that can be accessed to determine the amount of flow measured by the meter. For example, the data within the CTU can be transmitted to a utility base station for usage determination via wireless transmission, or via a line such as an electrical supply line. While the CTU can be connected to an electrical supply line, the data it transmits via the supply line can include electrical usage, water usage, or gas usage. The data packets can be analyzed for flow usage data as well as for testing, tampering, and possible component failures. The processor 54 is in communication with a non-volatile memory 56 capable of storing the data packets such that the data packets can be retrievable should the processor 54 lose power. Also connected to the processor 54 is a master clear and memory reset 60 capable of clearing all memory within the RTU 30, including the non-volatile memory 56 or simply resetting memory within the RTU.

In operation, the RTU 30 should be disposed proximate to the rotating wheel 20 such that the light produced by the LED's 34 is capable of reaching the rotating wheel 20 and being reflected back to the RTU 30. Moreover, the reflection from the rotating wheel 20 should be of sufficient magnitude to be registered by the detector array 33. As the rotating wheel 20 rotates in response to the sensed flow, the light reflected from the reflecting surface of the rotating wheel 20 and subsequently received by the detector array 33, will result in a “0” or low output signal emanating from the detector array 33. In contrast, a high or positive output signal is produced by the detector array 33 when no reflected light is directed onto it from the rotating wheel 20. The detector array 33 will experience no reflected light during the time the light absorbing painted strip 22 rotates past the LEDs 34 and the detector array 33—and thus a high or positive output signal will then be generated by the detector array 33. Recording the number of high or positive output signals produced by the detector array 33 translates into the number of revolutions experienced by the rotating wheel 20 during the time the RTU 30 is in operation. As is well known, the number of revolutions of the rotating wheel 20 can be directly correlated to the amount of flow sensed by the meter.

One of the advantages of using a detector array 30 with a flow meter is that the measurement of the meter will not be affected by the introduction of light from sources other than the LEDs 34. Additional advantages of the present invention include the ability to ascertain the angular direction of rotation of the rotating wheel 20. As previously described, possible tampering with the meter can be determined by knowing the rotational direction of the rotating wheel 20.

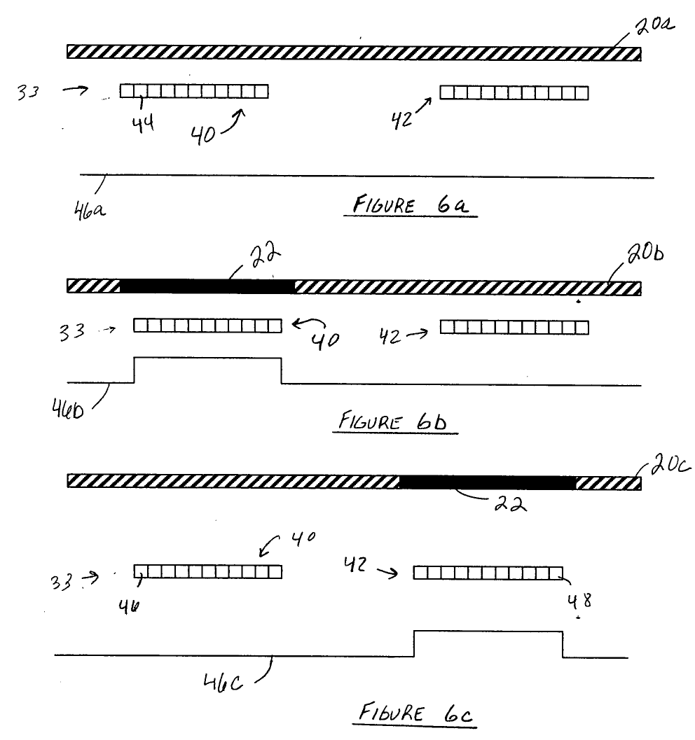

Referring now to FIGS. 6a through 6c, a more specific description of one embodiment of the present invention is shown. This series of figures demonstrates the relationship between the light reflected by the rotating wheel 20 (or absorbed by the painted strip 22) and the output signal generated by the detector array 33. FIGS. 6a through 6c also illustrate additional detail regarding the detector array 33. For example, while the detector array 33 can comprise a single pixel element 44 capable of receiving light and creating a corresponding signal, it is instead preferred that it include a series of pixel elements 44, such as can be found in a TSL201 1×64 array charge coupled device. For simplicity, only the first 11 and last 11 pixel elements 44 of the series are shown in FIGS. 6a through 6c; these two series of pixel elements 44 are referred to herein as the first series 40 and the second series 42. FIGS. 6a through 6c illustrate the relative location of the rotating wheel 20 with its associated painted strip 22 in relation to the first and second series (40, 42). These figures also include the output signals (46a-46c) generated by the detector array 33 in response to the location and proximity of the painted strip 22.

With reference now to FIG. 6a, a portion of the rotating wheel 20a is shown adjacent the detector array 33. It should be noted that the portion of the rotating wheel 20a of FIG. 6a does not include the painted strip 22, thus all of the light directed onto the rotating wheel 20 by the electromagnetic radiation source should be reflected back onto the entire detector array, and thus onto the first and second series (40, 42). As discussed above, since light is being received and registered by both the first and second series (40, 42) of the detector array 33, the corresponding output signal 46a will be in a “0” or low state.

FIG. 6b portrays operation of an embodiment of the present invention when the portion of the rotating wheel 20b adjacent the detector array 33 includes the painted strip 22. Here the painted strip 22 is shown facing the first series 40, thereby absorbing the light directed from the electromagnetic radiation source and preventing light reflection onto the first series 40. As such, the output-signal 46b emanating from the pixel elements 44 comprising the first series 40 will register a positive or high reading. With reference to FIG. 6c, the rotating wheel 20 has rotated such that the painted strip 22 on the segment of the rotating wheel 20c adjacent the detector array 33 is aligned with the second series 42. Similarly the presence of the painted strip 22 preventing reflective light from reaching the second series 42, which in turn causes the pixel elements comprising the second series 42 to have an output signal 46c that is positive or high.

Analyzing the output signals (46b, 46c) of FIGS. 6b and 6a reveals that passing the painted strip 22 past the detector array 33 can produce a “ripple” across the output signals (46b, 46c). One of the advantages of using an array of pixel elements instead of a pixel element is that the rotational direction of the rotating wheel 20 can be determined by evaluating the sequence of pixel elements having a high or positive output signal. For example, if typical rotation of the rotating wheel 20 resulted in the painted strip 22 exciting the first pixel elements 46 before the remaining pixel elements 44, but instead the last pixel element 48 were excited first, it could easily be determined that the rotating wheel 20 was rotating opposite to its normal rotation. Since opposite rotation of the rotating wheel can be evidence of meter tampering, quick detection of possible tampering can be obtained with the present invention.

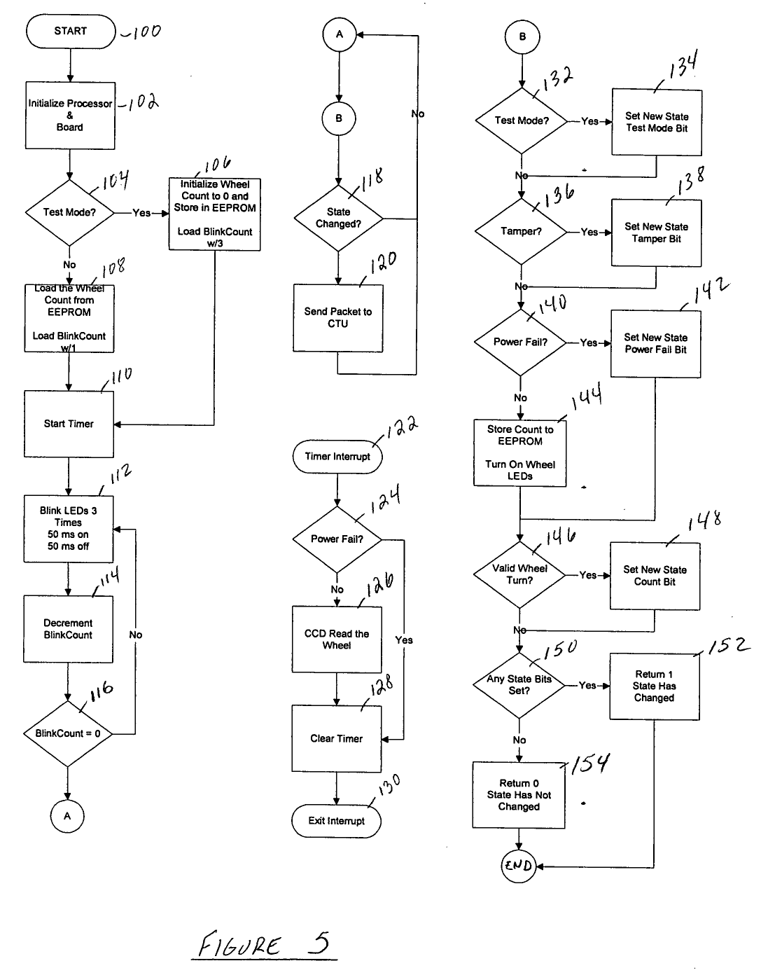

A processor 54 can be included with the present invention for the control, data checking, data storage, and data transmission tasks. The data transmissible by the processor 54 includes data packets having imbedded within the packets values representing energy sensed by the meter. As will be described in more detail below, the data packets transmissible by the processor 54 also include data providing information as to the test mode, tamper, and power failure. In one exemplary example the processor 54 can be a PIC16C622, where the processor 54 is controllable by firmware. FIG. 5 includes a flowchart describing firmware for use by one embodiment of the present invention.

Energizing the circuit containing the process allows the processor to start 100 and begin the initialization 102 of the processor and the associated circuit. After the initialization step 102, a query is made if the test mode 104 should occur, if so the wheel count will be set to zero and stored in erasable memory included with the circuit 106. The wheel count is the count of the actual number of times the wheel has rotated, the blink count is a number that is programmed into the logic of the present invention. If it is determined that the test mode 104 should not be done, the wheel count presently in erasable memory will be loaded and the blink count will be set to one 108. A command to start timer 110 is initiated after each of steps 106 and 108, afterwards a command is made to blink the LEDs 34 three times on and off 112. After the blink command 112 the value of the blink count is reduced by one 114 and the memory is queried for a blink count of zero 116. If the blink count is not zero, the process returns to step 112, if the blink count is zero, a query is made to see if the processor is in test mode 132. If the processor is in test mode 132, the new state test mode bit is set 134, if not, a query is made if tamper to the RTU 30 has occurred 136. Detecting tamper of the RTU 30 or associated meter hardware can be done this by looking at the progression of data previously transmitted by the processor. If tamper is detected, the processor firmware can direct the process to set a new state tamper bit 138, if no tamper is detected a query is made to determine if a power failure has occurred 140. If a power failure if determined to have occurred, the processor can be directed to set a new state power fail bit 142. If no power failure is detected, the count of the data packet can be stored into erasable memory 144, such as an erasable programmable read only memory. Step 144 also can include a command to provide power to the LEDs 34. After steps 142 and 144 a query is made determining if a valid wheel turn has occurred 146, i.e. in the proper direction of rotation. If a valid wheel count is detected, a new state count bit is set 148, a query is made to see if any state bits have been set 150—after step 148, the logic process directs the processor to step 150. If state bits have been set, then a value of one (or high value) is established for the state value 152, otherwise a value of zero (or low value).

The state value (either 0 or 1) is returned and evaluated to determine if a change has occurred in the value of the state, if the value of the state has changed the value, the data packet representative of the flow sensed by the meter is sent to a central terminal unit (not shown) 120, if not the logic process returns to step 132.

How often the data packets are sent can be based on programmed commands or on operational upset conditions. For example, the time frequency of sending the data packets from the processor to the CTU can be based on the wheel count, or upon the change of state of a data bit that can indicate an upset condition. Upset conditions can include tamper, power fail, or if the processor 54 is in test mode. An advantage of the flexibility of when the data packets are sent is realized when a problem with the meter, such as tamper or power failure, can be detected soon after this data is registered by the processor.

In instances where the present invention is used in conjunction with an electrical meter, power for the RTU 30 can be take directed from the electrical power supply on which the meter is located. The power supply can be either 240 VAC and connected to each of the primary electrical legs; or can be 120 VAC by connecting between one of the primary electrical legs and the common ground. When the power supplied to the RTU 30 is in the form of alternating current, a full wave rectifier can be included with the present invention, further a low voltage regulator can also be included for maintaining a constant low voltage for the associated logic circuits.

The present invention described herein, therefore, is well adapted to carry out the objects and attain the ends and advantages mentioned, as well as others inherent therein. While a presently preferred embodiment of the invention has been given for purposes of disclosure, numerous changes exist in the details of procedures for accomplishing the desired results. Such modifications will readily suggest themselves to those skilled in the art, and are intended to be encompassed within the spirit of the present invention disclosed herein and the scope of the appended claims.

What is claimed is:

1. A device for use with a meter, wherein the meter comprises a rotating wheel rotate able in response to a flow sensed by the electric meter, wherein the rotating wheel includes markings on its outer surface, comprising:
at least one electromagnetic radiation source capable of emitting electromagnetic radiation onto the rotating wheel, where at least a portion of the electromagnetic radiation emitted onto the rotating wheel is reflected away from the rotating wheel and at least a portion of the electromagnetic radiation emitted onto the rotating wheel is absorbed by the rotating wheel;
a detector array capable of receiving at least a portion of the electromagnetic radiation reflected from the wheel, wherein said detector array is capable of converting the electromagnetic radiation it receives into a signal, where the signal is representative of the flow sensed by the meter; and
an analyzer in operative cooperation with said detector array.

2. The device of claim 1, wherein said detector array comprises at least two separate arrays.

3. The device of claim 2, wherein said two separate arrays are spaced apart.

4. The device of claim 1, wherein said detector array comprises at least one charge coupled device.

5. The device of claim 1, wherein said source of electromagnetic radiation is a light emitting diode.

6. The device of claim 1, wherein the markings provide a surface capable of absorbing at least a portion of the electromagnetic radiation directed at the rotating wheel.

7. The device of claim 1, wherein the meter is selected from the group consisting of electrical meters, gas meters, and water meters.

8. The device of claim 1, wherein the signal is selected from the group consisting of an electrical signal, a pneumatic signal, and a wireless signal.

9. A method of measuring flow with a meter having a rotating wheel with markings provided on the rotating wheel, and a generally reflective surface on the remaining surface on the rotating wheel, wherein the rotating wheel is rotate able in response to the flow monitored by the meter comprising:
directing electromagnetic radiation at the rotating wheel, wherein at least a portion of the electromagnetic radiation is absorbable by the rotating wheel and at least a portion of the electromagnetic radiation is reflect able from the rotating wheel;
receiving at least a portion of the electromagnetic radiation reflected from the rotating wheel;
converting the electromagnetic radiation received into a signal; and
analyzing said electrical signal thereby determining the magnitude of the flow sensed by the meter.

10. The method of claim 9 further comprising absorbing at least a portion of the electro-magnetic radiation directed at the with the portion of the rotating wheel having the markings and reflecting at least a portion of the electromagnetic radiation directed at the rotating wheel with the reflective surface of the rotating wheel.

11. The method of claim 10, wherein the combination of the rotation of the rotating wheel with the reflections of the electromagnetic radiation directed at the rotating wheel interrupted by the passing of the electromagnetic radiation absorbing markings in the path of the electro-magnetic radiation directed at the rotating wheel creates a ripple while receiving at least a portion of the electromagnetic radiation reflected from the rotating wheel.

12. The method of claim 11, wherein said ripple is representative of the rotation of the rotating wheel, thereby also being representative of the rate of flow sensed by the electrical meter.

13. The method of claim 10 further comprising determining the direction of said ripple thereby determining the rotational direction of the rotating wheel.

14. The method of claim 9 further comprising using a detector array to receive at least a portion of the electromagnetic radiation reflected from the reflective surface of the rotating wheel.

15. The method of claim 14, wherein said detector array is comprised of a charge coupled device.

16. The method of claim 9, wherein the source of the electromagnetic radiation is at least one light emitting diode.

17. The method of claim 9, wherein the meter is selected from the group consisting of an electrical meter, a gas meter, and a water meter.

18. The method of claim 9, wherein the signal produced is selected from the group consisting of an electrical signal, a pneumatic signal, and a wireless signal.

19. A method of measuring flow to a user comprising:
Sensing flow to the user;
Producing data representative of the sensed flow; and
Forwarding said data to the provider of the flow.

20. The method of claim 19 further comprising forwarding said data to a central processing unit then forwarding the data to the provider of the flow.

21. The method of claim 20 further comprising storing the data within said central processing unit.

22. The method of claim 19 wherein said data is forwarded based on a preset time frequency.

23. The method of claim 19 wherein said data is forwarded based on an operational upset condition.
